(19) United States
(12) Patent Application Publication
(10) Pub. No.: US 2007/0150433 A1
(43) Pub. Date: Jun. 28, 2007

(54) Method for managing file in version control system

(75) Inventor: Pei-Wen Chen, Jhubei City (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: MEDIATEK INC.

(21) Appl. No.: 11/317,916

(22) Filed: Dec. 22, 2005

(51) Int. Cl. G06F 17/30

(52) U.S. Cl. 707/1

(57) ABSTRACT

A method for managing a target file in a version control system is provided. According to this invention, when a user requests to check-out, check-in, update, or add tags to an target file, the version control system operates on a substitute file instead of the target file. The substitute file is generated based on the target file and is much smaller than the target file. Thus, the time for opening and manipulating files can be saved.

### BACKGROUND OF THE INVENTION

1. Field of the Invention

The present invention is related to a file managing system. More specifically, the present invention relates to a version control system.

2. Description of the Prior Art

A version control system is a powerful and necessary tool for lots software or hardware developing groups. In a version control system, the revision history is stored in a single central server and the client machines respectively have a copy of the files that the developers are working on. Version control systems enable a plurality of people to work on the same files at the same time and further prevent version conflicts. With version control systems and networks, engineers around the world can co-work as a team conveniently. At present, the most popular version control system is called concurrent versions system (CVS).

As known by people skilled in the art, general CVS stores all the revisions of a file in a single file with the initial revision and the differences between the following revisions. Usually, a general CVS is used to manage versions of source codes. In some applications, users want to store codes or target files converted from source codes, rather than source codes themselves, because the converted codes take a lot of time to be converted. However, this kind of storing policy is not suitable for those codes translated from source codes, since the translated or converted codes are huge and a slight change in source codes may lead to completely different converted codes between versions. Comparing and manipulating differences between two revisions may take a lot of time. If a user just wants to add a small tag in a file, the huge single file with the initial revision and all the differences between the following revisions must be accessed, opened and manipulated. To open or manipulate files with sizes of hundreds of mega bytes not only takes a lot of time, but also occupies enormous hardware resources.

### SUMMARY OF THE INVENTION

To solve aforementioned problems, this invention provides a method for managing files in a version control system. According to this invention, when a user requests to check-out, check-in, update, or add tags to a target file, the version control system operates on a substitute file instead of the target file. The substitute file is generated based on the target file and is much smaller than the target file. Thus, the time for opening and manipulating files can be saved.

One preferred embodiment according to this invention is a method for adding a target file into a version control system. In this method, a substitute file is first generated based on the target file and checked-in into the version control system. Then, this method selects a storage space for storing the target file based on a predetermined rule. Subsequently, the target file is stored into the storage space. After the target file is stored into the storage space, if a request for accessing the target file is transmitted to the version control system, the substitute file stored in the version control system is first checked-out and the storage space for storing the target file is then found according to the substitute file and the predetermined rule.

The other preferred embodiment according to this invention is a method for managing N versions of a target file. A substitute file is previously generated based on the N versions of the target file and stored in a version control system. Each of the N versions of the target file is respectively stored in a storage space. In response to a check-out request transmitted to the version control system for checking-out the target file into a workspace, the method first judges whether any of the N versions of the target file has been checked-out into the workspace. If the judging result is NO, the substitute file is checked-out from the version control system into the workspace. According to a predetermined rule, the storage space for storing the revision of data can be found out. Then, the revision of data is copied from the storage space to the workspace.

The advantage and spirit of the invention may be understood by the following recitations together with the appended drawings.

### BRIEF DESCRIPTION OF THE APPENDED DRAWINGS

FIG. 1 is the flowchart of the method in a preferred embodiment according to this invention.

FIG. 2 shows the check-out flowchart of a preferred embodiment according to this invention.

FIG. 3 shows the check-in flowchart of a preferred embodiment according to this invention.

FIG. 4 shows the update flowchart of a preferred embodiment according to this invention.

FIG. 5 is another exemplary flow chart illustrating checking changes into the version control system.

FIG. 6 is another exemplary flow chart illustrating a checking-out procedure.

FIG. 7 is another exemplary flow chart illustrating a synchronization procedure (or update procedure).

### DETAILED DESCRIPTION OF THE INVENTION

One main purpose of this invention is to provide a method for managing files in a version control system. According to this invention, when a user requests to check-out, check-in, update, or add tags to a target file (i.e. a real file), the version control system operates on a substitute file instead of the target file. The substitute file is generated based on the target file but is much smaller than the target file. Therefore, the time for opening and manipulating files can be saved. Users can still use the same commands to communicate with the version control system. The method according to this invention would translate the commands and transmit the translated commands to the version control system. This method can be applied to a concurrent versions system (CVS) or any other version control systems.

In actual applications, the content of a substitute file can just be part of the meta-data of the target file. The meta-data may include revision numbers, time of revisions, names of modifier, and various tags.

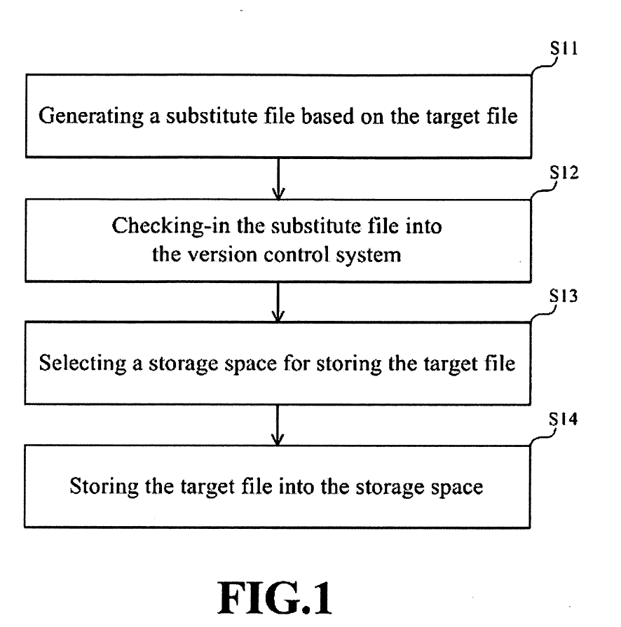

A preferred embodiment according to this invention is a method for adding a target file into a version control system. Please refer to FIG. 1. FIG. 1 is the flowchart of the method in the preferred embodiment according to this invention. The method first performs step S11 to generate a substitute file based on the target file. This target file is the real file (target file) that the user originally wants to check into the version control system from his workspace. Subsequently, step S12 is checking-in the substitute file into the version control system. Then, step S13 is selecting a storage space for storing the target file based on a predetermined rule. The predetermined rule could be selecting a particular path or directory for storing the target file. At last, step S14 is performed to store the target file into the storage space. After the target file is stored into the storage space, if a request for accessing the target file is transmitted to the version control system, the substitute file stored in the version control system is first checked-out and the storage space for storing the target file is then found according to the substitute file and the predetermined rule. That is, the path for storing the target file is found and then the target file can be retrieved from the storage space to the workspace.

In actual applications, the predetermined rule can be a specified mapping relation between the substitute file and the storage space for storing the target file. The predetermined rule can be decided by users.

The other preferred embodiment according to this invention is a method for managing a target file including N versions, wherein N is a natural number. A substitute file is previously generated based on the N versions of the target file and stored in a version control system. Each of the N versions of the target file is respectively stored in a storage space. The storage spaces for storing the N revisions are selected based on the aforementioned predetermined rule.

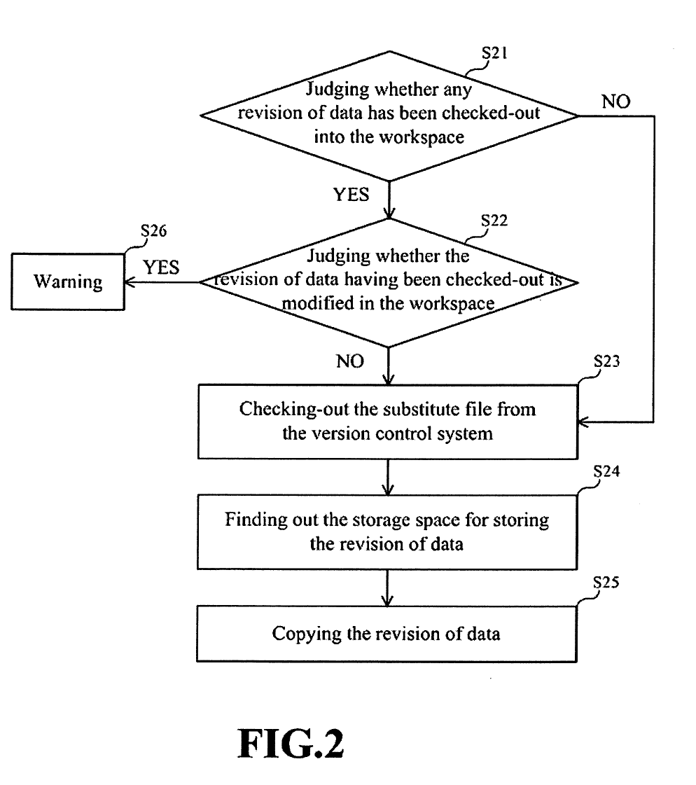

Please refer to FIG. 2. FIG. 2 shows the check-out flowchart of a preferred embodiment according to this invention. When a user transmits a check-out request to the version control system for checking-out the target file (that is, a real file) into a workspace, steps S21 through S27 are performed. Step S21 is judging whether any of the N versions of the target file has been checked-out into the workspace.

If the judging result of step S21 is NO, steps S23 through S25 are then performed. Step S23 is checking-out the substitute file from the version control system into the workspace. The user can determine which version number (or revision number) of the target file is to be checked out. For example, if the target file includes 6 versions of target file, the newest revision number might be 1.6. If the user chooses to check out the newest revision number of the target file, the storage space for storing the revision of data corresponding to the revision number can be found, according to a predetermined rule, in step S24. Similarly, if the user decides to check out the version 1.5 of the target file, a corresponding path of the stored target file (version 1.5) can be found and the version 1.5 target file can be retrieved. However, there are several ways to identify a version by a user. For example, the user can decide to check out a version according to the version's establishing time or an alias, tag, or label for the version of the target file. The establishing time or the alias is easier for the user to remember than the version number having no meaning to the user. The mapping relationship between the establishing time, the alias and the revision number can be implemented by a program or be a default function of the version control system selected. Thereafter, step S25 is copying the revision of data corresponding to the revision number from the storage space to the workspace.

If the judging result of step S21 is YES, step S22 is then performed to judge whether the revision of data (i.e. the target file) having been checked-out into the workspace is modified in the workspace. If the judging result of step S22 is NO, steps S23 through S25 are also performed. If the judging result of step S22 is YES, thus it can be seen that at least one of the N versions of the target file has ever been checked-out into the workspace as a local revision of data, and the substitute file has also been checked-out into the workspace as a local substitute file. Step S26 sends a first warning to the workspace to indicate a modification has occurred. The user of the workspace would be queried whether he/she wants to reserve the local revision of data or just replace the local revision of data by the revision of data from the version control system. At the same time, the local substitute file can be modified to record that the local revision of data is modified.

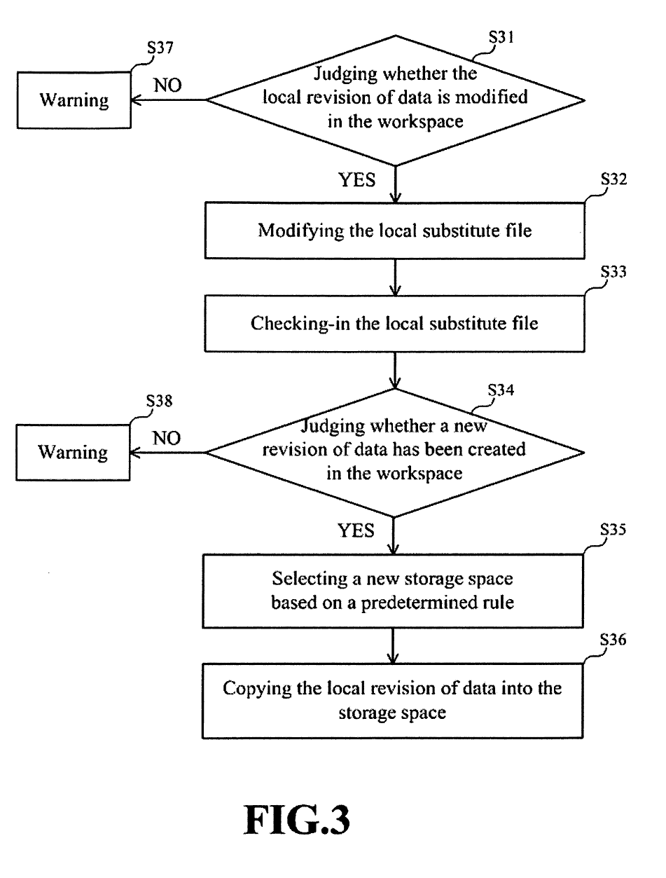

Please refer to FIG. 3. FIG. 3 shows the check-in flowchart of a preferred embodiment according to this invention. Assume at least one of the N versions of the target file has ever been checked-out into a workspace as a local revision of data, and the substitute file has ever been checked-out into the workspace as a local substitute file. When a user at the workspace has modified the local revision of data and wants to store the local revision of data into the version control system, a check-in request would be transmitted to the version control system. In response to the check-in request, step S31 is first performed to judge whether the local revision of data is really modified in the workspace. If the judging result of step S31 is YES, step S32 is performed to modify the local substitute file to record that the local revision of data is modified. Step S33 then checks-in the local substitute file into the version control system. Step S34 is judging whether the check-in action is performed successfully. That is, judging whether a new revision of the substitute file is created by the version control system. If the judging result of step S34 is YES, step S35 is then performed to select a new storage space for storing the local revision of data based on the predetermined rule. At last, step S36 is performed to copy the local revision of data from the workspace into the new storage space. If the judging result of step S31 is NO, step S37 sends a second warning to the workspace to indicate no modification. If the judging result of step S34 is NO, step S38 is sending a third warning to the workspace to indicate an unsuccessful check-in.

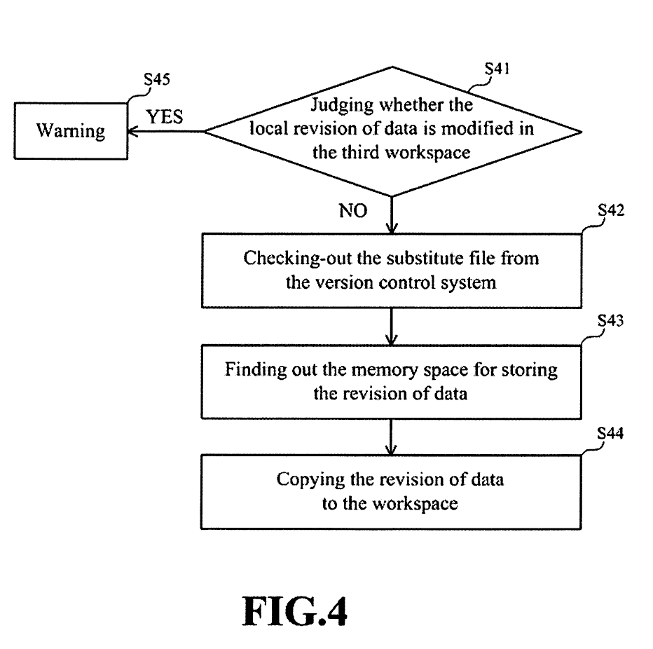

Please refer to FIG. 4. FIG. 4 shows the update flowchart of a preferred embodiment according to this invention. Assume at least one of the N versions of the target file has ever been checked-out into a workspace as a local revision of data, and the substitute file has ever been checked-out into the workspace as a local substitute file. When a user at the workspace requests to update the local revision of data, an update request would be transmitted to the version control system. In response to the update request, step S41 is first performed to judge whether the local revision of data is really modified in the workspace. If the judging result of step S41 is NO, step S42 through S44 are then performed. Step S42 is checking-out the substitute file from the version control system into the workspace. According to the predetermined rule, step S43 then finds out the storage space for storing the revision of data. Step S44 is copying the revision of data from the storage space into the workspace. If the judging result of step S41 is YES, step S45 is performed to send a fourth warning to the workspace to indicate a modification has occurred.

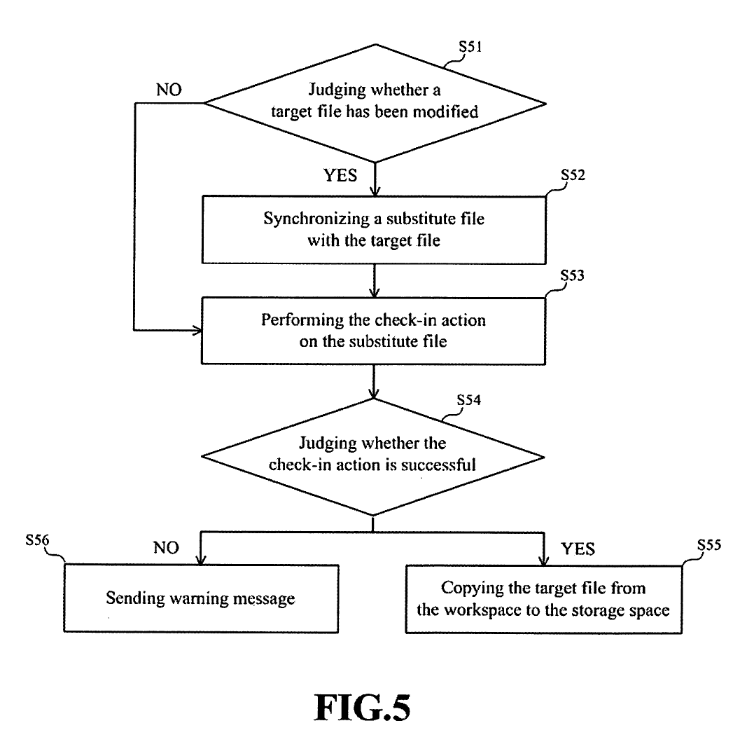

FIG. 5 is another exemplary flow chart illustrating checking changes into the version control system. A target file is checked to determine whether it has been modified (step S51). For example, checking the creation or modification time of the target file is a simple test. If the target file has been modified, then a substitute file is synchronized with the target file (step S52). In this embodiment, current time is appended to the substitute file to accomplish the synchronization (step S52). In another embodiment, the synchronization can be achieved by appending a random number to the substitute file. In the other embodiment, the synchronization can be achieved by modifying the substitute file. Then, step S53 is performing the check-in action on the substitute file. If the target file has not been modified (that is, the substitute file has already been synchronized with the target file), the substitute file is directly checked into the version control system in step S53. That is, the version control system commits the substitute file in step S53.

After that, the version control system determines whether the check-in is successful in step S54. If a new version of the substitute file is created in the version control system, the check-in is considered successful. Then the target file is copied from the workspace to the storage space in step S55. If the new version of the substitute file is not created in the version control system, the check-in is not successful and a message is sent to the user in step S56. If the result of step S51 is NO, we can expect that the result of step S54 is NO because the check-in action is needless. In this embodiment, the substitute file, instead of the target file, is checked into the version control system. Because the substitute file is far smaller than the target file, it is more efficient to check in the substitute file than the target file. Moreover, for each new version of the substitute file, only a line of time information is added, so the version control system can easily handle the tiny substitute file. Therefore, it would be far more convenient to use a substitute file than the target file.

The storage path of the target file (stored in the storage space) can be generated by a predetermined rule. The predetermined rule can be, for example, creating a path according to the path name and the version number of the target file. If a substitute file is stored as $ CVSROOT/dir/.substitute.fileA,v (.substitute.fileA,v is the substitute file, and fileA is the name of the target file), the corresponding target file can be stored as $ CVSROOT/dir/CVS/fileA/1.4 (1.4 is the version number of the target file, file A.). In another embodiment, the storage path of the target file is recorded.

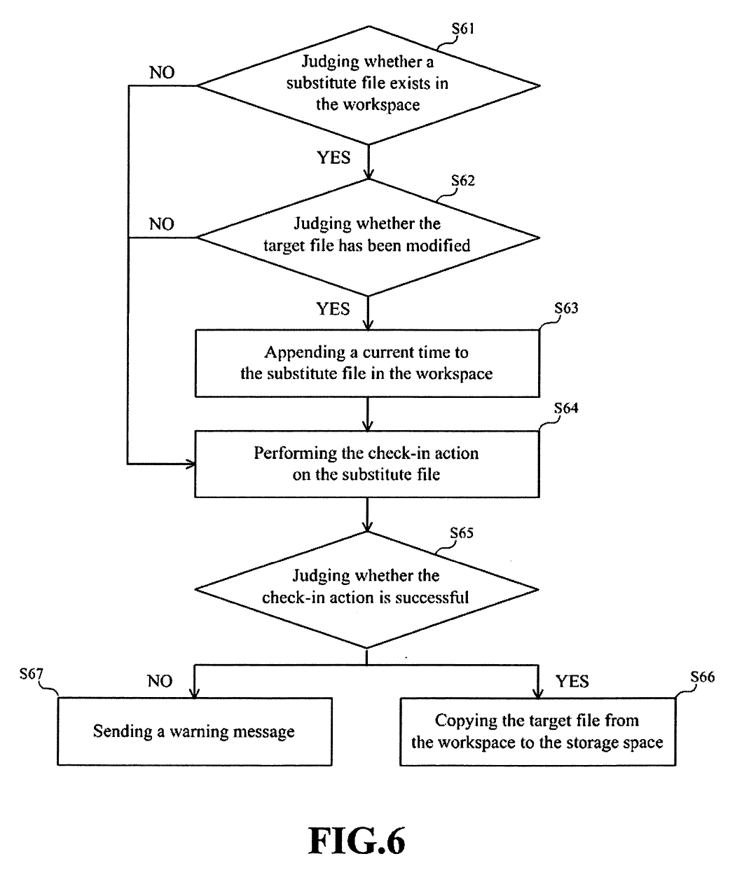

FIG. 6 is another exemplary flow chart illustrating a checking-out procedure. First, step S61 is performed to determine whether a substitute file exists in the workspace. If the substitute file exists, the target file is checked to determine whether it has been modified in step S62. If the substitute file does not exist, a substitute file is checked out from the version control system in step S64.

After step S62, if the target file has been modified, then a current time is appended to the substitute file in the workspace to synchronize the substitute file with the target file in step S63. Then, step S64 is performed after step S63. The user can determine which version of substitute file is to be checked out. If the newest version of the substitute file is to be checked out from the version control system, it would not success because the substitute file has been modified in the workspace. Thus, the newest version of the substitute file is not checked out from the version control system and the version control system sends a message to the user (step S65 and step S67).

After step S62, if the target file (assume that the local version is already the newest one) has not been modified and the newest version of the substitute file is decided to be checked out from the version control system in step S64, it won't success. That is, the newest version of the substitute file will not be checked out because the local substitute file is already the newest one and is not modified. Therefore, the newest version of the substitute file will not be created or modified in the workspace. Then, a message is sent to the user that the creation of the newest substitute file is not made.

If an older version of the substitute file is decided to be checked out from the version control system, and if the target file is not modified in the workspace, it would be successfully checked out because there is no version confliction.

However, if an older version of the substitute file is decided to be checked out from the version control system, and if the target file is modified in the workspace, it would be not successfully checked out and a message will be sent to the user showing that the target file has been modified.

If the substitute file is successfully checked out, a substitute file (the older version) is created in the workspace. Then, the target file corresponding to the older version substitute file is copied from the version control system to the workspace in step S66.

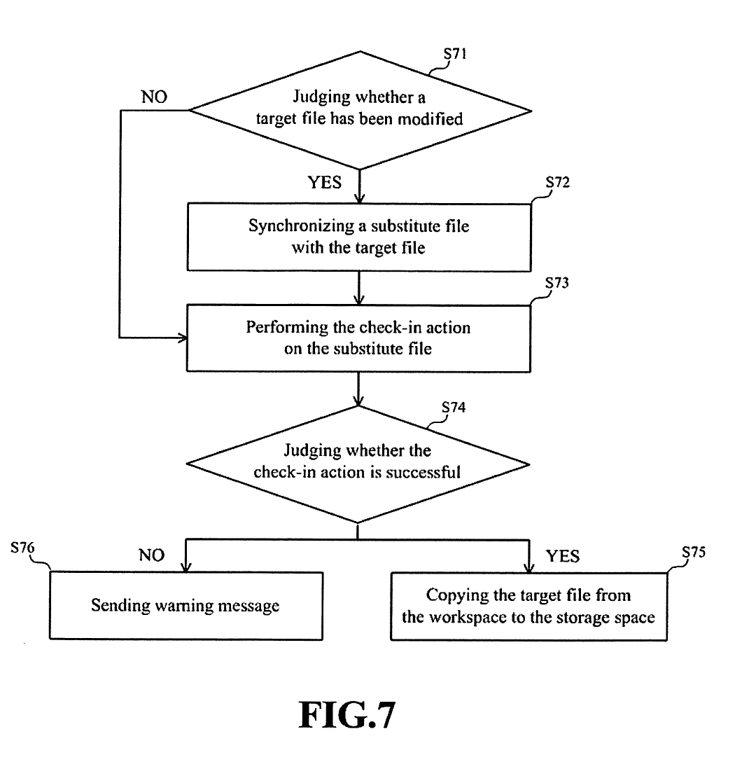

FIG. 7 is another exemplary flow chart illustrating a synchronization procedure (or update procedure). First, step S71 is performed to determine whether the target file has been modified in the workspace. If the target file has been modified, then current time is appended to the substitute file in the work space to synchronize the substitute file with the target file in step S72. Then, step S73 is performing the update action on the substitute file. The user can determine which version of substitute file is to be updated. If the newest version of the substitute file is to be updated, it would not success because the substitute file has been modified in the workspace. Thus, the newest version of the substitute file is not checked out from the version control system and the version control system sends a message to the user (step S74 and step S76).

After step S71, if the target file (assume that the local version is already the newest one) has not been modified and the newest version of the substitute file is decided to be checked out from the version control system (i.e. to be updated) in step S74, it won't success. That is, the newest version of the substitute file will not be checked out because the local substitute file is already the newest one and is not modified. Therefore, the newest version of the substitute file will not be created or modified in the workspace. Then, in step S76, a message is sent to the user that the creation or modification of the newest substitute file is not made. That is, the process of synchronization is not successful.

If an older version of the substitute file is decided to be checked out from the version control system (i.e. the older version of the substitute file is to be updated), and if the target file is not modified in the workspace, it would be successfully checked out because there is no version confliction.

However, if an older version of the substitute file is decided to be checked out from the version control system, and if the target file is modified in the workspace, the check-out would not be successfully and a message will be sent to the user showing that there has been a modification to the target file.

When the older version of the substitute file is checked out, the target file corresponding to the older version substitute file is copied from the version control system to the workspace in step S75. Thus, the target file and substitute file are brought in synchronous with those in the version control system.

According to this invention, in response to a tag or label request transmitted to the version control system for adding a tag to the target file, the substitute file in the version control system is added the tag such that the version control system does not have to open the target file. Similarly, in response to a log or history request transmitted to the version control system for viewing a set of history record corresponding to the target file, the set of history record recorded in the substitute file is shown instead of the target file itself.

The methods according to this invention can be applied to a concurrent versions system (CVS) or any other version control systems. Since the method mostly operates on a small substitute file, users can open and manipulate files more efficiently than prior arts.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for adding an target file into a version control system, comprising the steps of:
generating a substitute file based on the target file;
checking-in the substitute file into said version control system;
selecting a storage space for storing the target file based on a predetermined rule; and
storing the target file into the storage space;
wherein after the target file is stored into the storage space, when a request for accessing the target file is transmitted to said version control system, the substitute file stored in the version control system is first checked-out and the storage space for storing the target file is then found according to the substitute file and the predetermined rule.

2. The method of claim 1, wherein the version control system is a concurrent versions system (CVS).

3. A method for managing a target file comprising N versions, N being a natural number, a substitute file being previously generated based on the N versions of the target file and stored in a version control system, each of the N versions of the target file being respectively stored in a storage space, said method comprising the steps of:
in response to a check-out request transmitted to the version control system for checking-out the target file into a workspace, the following sub-steps being performed:
(a1) judging whether any of the N versions of the target file has been checked-out into said workspace, if NO, performing the sub-steps (a2) through (a4);
(a2) checking-out the substitute file from the version control system into said workspace;
(a3) according to a predetermined rule, finding out the storage space for storing the revision of data; and
(a4) copying the revision of data from the storage space to said workspace.

4. The method of claim 3, wherein if the judging result of the sub-step (a1) is YES, the following sub-step is performed:
(a5) judging whether the revision of data having been checked-out into said workspace is modified in said workspace, if NO, performing the sub-steps (a2) through (a4).

5. The method of claim 4, wherein if the judging result of the sub-step (a5) is YES, the following sub-step is performed:
(a6) sending a first warning to said workspace to indicate a modification has occurred.

6. The method of claim 5, wherein at least one of the N versions of the target file has ever been checked-out into said workspace as a local revision of data, the substitute file has been checked-out into said workspace as a local substitute file, and if the judging result of the sub-step (a5) is YES, the following sub-step is also performed:
(a7) modifying the local substitute file to record that the local revision of data is modified.

7. The method of claim 3, wherein at least one of the N versions of the target file has ever been checked-out into said workspace as a local revision of data, and the substitute file has ever been checked-out into said workspace as a local substitute file, said method further comprising the steps of:
in response to a check-in request transmitted to the version control system for checking-in the local revision of data from the workspace, the following sub-steps being performed:
(b1) judging whether the local revision of data is modified in said workspace, if YES, modifying the local substitute file to record that the local revision of data is modified;
(b2) checking-in the local substitute file into the version control system;
(b3) judging whether a new revision of substitute file has been created, if YES, proceeding to step (b4);
(b4) selecting a new storage space for storing the local revision of data based on said predetermined rule; and
(b5) copying the local revision of data from the workspace into the new storage space.

8. The method of claim 7, wherein if the judging result of the sub-step (b1) is NO, the following sub-step is performed:
(b6) sending a second warning to said workspace to indicate no modification.

9. The method of claim 7, wherein if the judging result of the sub-step (b3) is NO, the following sub-step is performed:
(b7) sending a third warning to said workspace to indicate an unsuccessful check-in.

10. The method of claim 3, wherein at least one of the N versions of the target file has ever been checked-out into said workspace as a local revision of data, and the substitute file has ever been checked-out into said workspace as a local substitute file, said method further comprising the steps of:
in response to an update request transmitted to the version control system for updating the local revision of data, the following sub-steps being performed:
(c1) judging whether the local revision of data is modified in said workspace, if NO, performing the steps (c2) through (c4);
(c2) checking-out the substitute file from the version control system into said workspace;
(c3) according to said predetermined rule, finding out the storage space for storing the revision of data; and
(c4) copying the revision of data from the storage space to said workspace.

11. The method of claim 10, if the judging result of the sub-step (c1) is YES, the following sub-step is performed:
(c6) sending a fourth warning to said workspace to indicate a modification has occurred.

12. The method of claim 3, said method further comprising the steps of:
in response to a tag request transmitted to the version control system for adding a tag to the target file, the following sub-step being performed:
(d1) recording a tag corresponding to the substitute file.

13. The method of claim 3, said method further comprising the steps of:
in response to a log request transmitted to the version control system for viewing a set of history record corresponding to the target file, the following sub-step being performed:
(e1) showing the set of history record recorded in the substitute file.

14. The method of claim 3, wherein the version control system is a concurrent versions system (CVS).

15. A method for managing versions of a target file, the method comprising:
synchronizing a substitute file with a version of the target file;
checking the substitute file, instead of the version of the target file, into a version control system; and
copying the version of the target file into a storage space;
wherein a storage path of the version of the target file is generated so that once the substitute file is identified, the storage path of the version of the target file is found.

16. The method of claim 15, wherein the storage path of the version of the target file is recorded.

17. The method of claim 15, wherein the storage path of the version of the target file is generated according to a predetermined rule.

18. The method of claim 15, wherein the version control system is a concurrent versions system (CVS).

19. The method of claim 15, wherein the step of synchronizing further comprising:
appending current time to the substitute file.

20. The method of claim 15, wherein the step of synchronizing further comprising:
appending a random number to the substitute file.

21. A method for managing versions of a target file, the method comprising:
checking a substitute file, instead of the version of the target file, out of a version control system; and
copying a version of the target file from a storage space;
wherein a storage path of the version of the target file is generated so that once the substitute file is identified, the storage path of the version of the target file is found.

22. The method of claim 21, wherein the version control system is a concurrent versions system (CVS).

23. The method of claim 21, further comprising:
before checking out a substitute file from the version control system, synchronizing substitute file with the version of the target file.
